(19) United States
(12) Patent Application Publication
(10) Pub. No.: US 2019/0056182 A1
(43) Pub. Date: Feb. 21, 2019

(54) HEAT EXCHANGER AND METHOD OF MAKING THEREOF

(71) Applicant: Taylor Commercial Foodservice Inc., Rockton, IL (US)

(72) Inventors: Kevin Henry Bischel, Rockton, IL (US); Michael Meserole, Janesville, WI (US)

(73) Assignee: Taylor Commercial Foodservice Inc., Rockton, IL (US)

(21) Appl. No.: 16/059,356

(22) Filed: Aug. 9, 2018

Related U.S. Application Data
(60) Provisional application No. 62/547,268, filed on Aug. 18, 2017.

(51) Int. Cl. F28F 1/16; B23P 15/26

(52) U.S. Cl. CPC F28F 1/16; A23G 9/045; B23P 15/26

(57) ABSTRACT

A method of making a heat exchanger includes providing an inner tube extending longitudinally along a central axis and having an inner surface bounding a product chamber and an outer surface. An outer tube is formed and positioned about the inner tube. The outer tube is disposed coaxially about and circumscribing the inner tube in a radially spaced relationship. Forming the outer tube and positioning the outer tube about the inner tube occur simultaneously.

### RELATED APPLICATION

The present patent document claims the benefit of the filing date under 35 U.S.C. § 119(e) of Provisional U.S. Patent Application Ser. No. 62/547,268, filed Aug. 18, 2017, which is hereby fully incorporated by reference herein.

### BACKGROUND

This disclosure relates generally to heat exchangers for freezing and dispensing semi-frozen products and, more particularly, to an improved heat exchanger for removing heat from the product within the product freezing chamber of the dispensing apparatus.

Soft-serve ice cream, yogurt, custard and other semi-frozen food products, as well as semi-frozen drinks, sometimes referred to as slushes, are commonly dispensed through a dispensing apparatus having a heat exchanger in the form of a freezing cylinder. The freezing cylinder, also referred to as a freezing barrel, defines a longitudinally elongated freezing chamber. Typically, unfrozen liquid product mix is added to the freezing chamber at the aft end of the freezing cylinder and selectively dispensed at the forward end of the freezing cylinder through a manually operated dispensing valve. A rotating beater, typically formed by two or more helical blades driven by a drive motor at a desired rotational speed, scrapes semi-frozen mixture from the inner wall of the freezing cylinder and moves the product forwardly through the freezing chamber defined within the freezing cylinder as the product transitions from a liquid state to a semi-frozen state. The product within the freezing chamber changes from a liquid state to a semi-frozen state as heat is transferred from the product to a refrigerant flowing through an evaporator disposed about the freezing cylinder. The evaporator is operatively associated with and part of a conventional refrigeration system that also includes a compression device and a refrigerant condenser arranged in a conventional refrigerant cycle in a closed refrigerant circuit. Dispensing apparatus of this type may have a single freezing cylinder for dispensing a single flavor of product or a plurality of freezing cylinders, each housing a selected flavor of product, for dispensing each of the selected flavors and even a mix of flavors.

As noted previously, heat is removed from the product within the freezing cylinder and carried away by a refrigerant circulating through an evaporator disposed about the freezing cylinder. In a dispensing apparatus having more than one freezing cylinder, an evaporator is disposed about each freezing cylinder. In a conventional apparatus for dispensing semi-frozen products, the evaporator is typically configured either as a tube wound around and in contact with the outside wall of the freezing cylinder or as an annular chamber from between the outside wall of the freezing cylinder and the inside wall of an outer cylinder disposed coaxially about the freezing cylinder. Published international patent publication WO2010/151390 discloses a freezing cylinder having an evaporator including a plurality of channels disposed about the outer surface of an inner cylinder. While this design is well suited for its intended purposes, improvements in such freezing cylinders would be well received in the art.

### BRIEF SUMMARY

According to an embodiment, a method of making a heat exchanger includes providing an inner tube extending longitudinally along a central axis and having an inner surface bounding a product chamber and an outer surface. An outer tube is formed and positioned about the inner tube. The outer tube is disposed coaxially about and circumscribing the inner tube in a radially spaced relationship. Forming the outer tube and positioning the outer tube about the inner tube occur simultaneously.

In addition to one or more of the features described above, or as an alternative, in further embodiments forming the inner tube further comprises forming one or more wraps of a sheet of material about the plurality of fins.

In addition to one or more of the features described above, or as an alternative, in further embodiments an adhesive is positioned on a surface of the sheet of material.

In addition to one or more of the features described above, or as an alternative, in further embodiments forming one or more wraps of a sheet of material about the plurality of fins further comprises: affixing an end of the sheet of material to an outer surface of the inner tube and rotating the inner tube about the central axis.

In addition to one or more of the features described above, or as an alternative, in further embodiments tension is applied to a sheet of material as the inner tube rotates about the central axis.

In addition to one or more of the features described above, or as an alternative, in further embodiments affixing the end of the sheet of material to the outer surface of the inner tube includes welding the end of the sheet of material to the outer surface of the inner tube.

In addition to one or more of the features described above, or as an alternative, in further embodiments the outer surface of the inner tube further comprises a feature for receiving an end of the sheet of material, and affixing the end of the sheet of material to the outer surface of the inner tube includes affixing the end of the sheet of material to the feature.

In addition to one or more of the features described above, or as an alternative, in further embodiments the feature includes a fin of the plurality of fins, the fins having a reduced height relative to a remainder of the plurality of fins.

In addition to one or more of the features described above, or as an alternative, in further embodiments comprising affixing another end of the sheet of material to an adjacent surface.

In addition to one or more of the features described above, or as an alternative, in further embodiments the adjacent surface is a portion of the sheet of material.

In addition to one or more of the features described above, or as an alternative, in further embodiments the end and the another end are offset from one another about a circumference of the inner tube.

In addition to one or more of the features described above, or as an alternative, in further embodiments rotating the inner tube about the central axis includes rotating the inner tube more than 360 degrees about the central axis such that at least a portion of the outer tube includes overlapping layers of the sheet of material.

In addition to one or more of the features described above, or as an alternative, in further embodiments comprising forming at least one of an inlet opening and an outlet opening in the outer tube.

In addition to one or more of the features described above, or as an alternative, in further embodiments forming at least one of an inlet opening and an outlet opening in the outer tube and forming the outer tube occur simultaneously.

In addition to one or more of the features described above, or as an alternative, in further embodiments at least one of the inlet opening and the outlet opening is generally conical in shape.

In addition to one or more of the features described above, or as an alternative, in further embodiments, a plurality of channels is disposed circumferentially between the outer tube and the inner tube.

In addition to one or more of the features described above, or as an alternative, in further embodiments the plurality of channels is formed into at least one of the inner tube and the outer tube.

In addition to one or more of the features described above, or as an alternative, in further embodiments the plurality of channels is formed via an insert located between the inner tube and the outer tube.

According to another embodiment, a heat exchanger includes an inner tube extending longitudinally along a central axis and having an inner surface bounding a product chamber and an outer surface. A plurality of channels are disposed at circumferentially spaced intervals in alternating relationship with a plurality of fins about a circumference of the outer surface of the inner tube. A longitudinally extending outer tube is disposed coaxially about and circumscribing the inner tube in a radially spaced relationship. The outer tube has an inner surface contacting the plurality of fins of the inner tube. The outer tube is formed from a sheet metal material and at least a portion of the outer tube includes a plurality of stacked layers of the sheet metal material.

In addition to one or more of the features described above, or as an alternative, in further embodiments the outer tube is formed from a sheet metal material wrapped about the outer surface of the inner tube.

In addition to one or more of the features described above, or as an alternative, in further embodiments the plurality of fins are integrally formed with the inner tube.

Other aspects, features, and techniques of the invention will become more apparent from the following description taken in conjunction with the drawings.

### BRIEF DESCRIPTION OF THE DRAWINGS

Referring now to the drawings wherein like elements are numbered alike in the several FIGURES:

FIG. 1 is a schematic diagram illustrating an example of an apparatus for freezing and dispensing a semi-frozen product;

FIG. 2 is a perspective view of an example of a freezing barrel;

FIG. 3 is a perspective view of the inner cylinder of the freezing barrel of FIG. 2 according to an embodiment;

FIG. 4 is a sectioned side elevation view of the inner cylinder of FIG.3 according to an embodiment;

FIG. 5 is a cross-sectional elevation view of the inner cylinder of FIG. 3 taken along line 5-5 with the outer cylinder assembled circumferentially about the inner cylinder according to an embodiment;

FIG. 6 is a magnified view of a segment of the freezing barrel defined within line 6-6 of FIG. 5 according to an embodiment;

FIG. 6A is a exploded cross-sectional view of the freezing barrel according to an embodiment;

FIG. 7 is perspective view of a sheet of material having a first end attached to the inner tube according to an embodiment;

FIG. 8 is a cross-sectional view of FIG. 7 taken in a plane perpendicular to the longitudinal axis of the freezing barrel according to an embodiment;

FIG. 9 is a perspective view of an inner tube having a material wrapped about an exterior surface of the inner tube according to an embodiment;

FIG. 10 is a perspective view of a freezing barrel having an outer tube including at least one inlet opening and outlet opening according to an embodiment;

FIG. 11 is a perspective view of a system for supporting and driving an inner tube about the longitudinal axis according to an embodiment; and

FIG. 12 is a method of forming an outer tube about an inner tube according to an embodiment.

### DETAILED DESCRIPTION

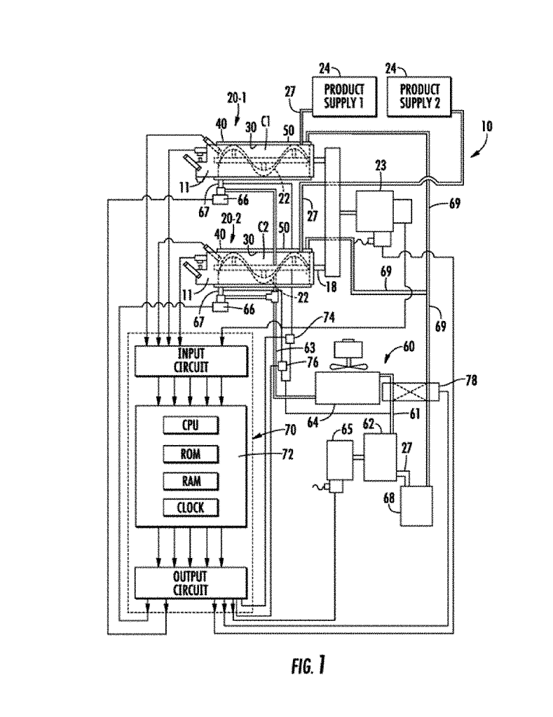

Referring initially to FIG. 1, a schematic diagram of an apparatus 10 for freezing and dispensing semi-frozen food products is illustrated. Examples of semi-frozen food products contemplated herein include, but are not limited to, soft-serve ice cream, ice milk, yogurt, custard, shakes, and carbonated and/or non-carbonated ice slush drinks.

In the illustrated non-limiting embodiment, the apparatus 10 includes two freezing chambers CI and C2 for dispensing food products of different flavors or types. The freezing chambers CI and C2 are defined within the axially elongated cylindrical barrels 20-1 and 20-2, respectively. Although shown as a dual barrel dispenser, it is to be understood that the apparatus 10 may have only a single barrel machine for dispensing a single product or may have three or more barrels for dispensing a plurality of flavors or types of products or a mix of flavors. Each of the barrels 20-1, 20-2 includes an inner cylinder 30, an outer cylinder circumscribing the inner cylinder 30 and an evaporator 50 formed between the inner cylinder 30 and the outer cylinder 40. Refrigerant is supplied from a refrigeration system 60 to the evaporators 50 of the respective barrels 20-1, 20-2 for refrigerating product resident within the respective freezing chambers CI and C2.

A beater 22 is coaxially disposed and mounted for rotation within each of the chambers CI and C2. Each beater 22 is driven by a drive motor 23 to rotate about the axis of its respective one of the barrels 20-1, 20-2. In the embodiment depicted in FIG. 1, a single drive motor, when energized, simultaneously drives each of the beaters 22 in rotation about the axis of its respective barrel. However, it is to be understood that each beater 22 may be driven by a motor dedicated solely to driving that respective beater. A respective product supply 24 is operatively associated with each of the barrels 20-1, 20-2 for supplying product to be frozen to the respective chamber CI and C2 with which the product supply is associated. The apparatus 10 is also equipped with a dispensing valve system 11 that is selectively operable for dispensing the semi-frozen product from the barrels in a manner well known in the art.

The refrigeration system 60 includes a compressor 62 driven by a compressor motor 65 operatively associated with the compressor 62, and condenser 64 connected with the evaporators 50 in a refrigerant circuit according to refrigeration cycle. It is understood that multiple compressors may be used, with an individual compressor designated for each evaporator. The compressor 62 is connected in refrigerant flow communication by high pressure outlet line 61 connected to the refrigerant inlet to the condenser 64 and the refrigeration outlet of the condenser 64 is connected through a high pressure refrigerant supply line 63 to refrigerant flow control valves 66, one of which being operatively associated with one of the evaporators 50 of barrel 20-1 and the other being operatively associated with the other of the evaporators 50 of barrel 20-2.

Each of the valves 66 is connected by a respective refrigerant line 67 to the refrigerant inlet of the respective evaporator 50 associated therewith. A respective refrigerant outlet of each evaporator 50 is connected through a low pressure refrigerant return line 69 and an accumulator 68 to the suction side of the compressor 62. The refrigerant flow control valves 66 may, for example, comprise on/off solenoid valves of the type which can be rapidly cycled between an open position passing flow of refrigerant to an associated evaporator 50 and a closed position blocking flow of refrigerant to an associated evaporator. The valves 66 may be implemented using a variety of devices including, but not limited to, pulse width modulated solenoid valves, electronic motor operated valves, automatic expansion valves, thermal expansion valves, ejectors, etc. In the illustrated, non-limiting embodiment, valves 74 and 76 connect the compressor outlet directly to evaporators 50 to enable hot gas heating of product in barrels 20-1 and 20-2. Four way valve 78 allows the system to run in a reverse gas mode, where the evaporators 50 serve as condensers, the heat product in barrels 20-1 and 20-2. However, in other embodiments, in place of the hot gas heating, electrical resistance heaters may be arranged in contact with the exterior of the evaporator 50.

Different products have different thermal transfer rates and different freezing points. Therefore, operation of the refrigeration system 60 will vary dependent upon the products being supplied to the freezing chambers CI and C2. Operation of the refrigeration system 60 may be controlled by a control system 70 that controls operation of the compressor drive motor 65, the beater motor 23, and the flow control valves 66. The control system 70 includes a programmable controller 72 that includes a central processing unit with associated memory, input and output circuits, and temperature sensors for sensing the temperature of the product within the chambers CI and C2. For a more thorough discussion of the design and operation of an exemplary control system 70 reference is made to U.S. Pat. No. 5,205,129, the disclosure of which is hereby incorporated by reference in its entirety.

In the depicted embodiment, each barrel 20 is equipped with a selectively operable dispensing valve 11 disposed at the forward end of the barrel 20 for receiving product from the freezing chamber. However, as in some conventional dual barrel dispensers, the dispensing valve system may include a third dispensing valve selectively operable to dispense a mix of the two flavors or types of products present in the mixing chambers CI and C2. The dispensing valve system may also comprise a single selectively operable valve that is selectively positionable in a first position to dispense product from chamber CI only, in a second position to dispense product from chamber C2 only, and in a third position to dispense mix of the products from both chambers CI and C2.

Briefly, in operation, product to be frozen is supplied to each of the chambers CI and C2 from the respective product supply 24 associated therewith from a supply tube 27 opening into the chamber at the aft end of each barrel 20. The product supplies 24 are arranged, as in conventional practice, to feed as required a liquid comestible product mix and generally, but not always, an edible gas, such as for example, air, nitrogen, carbon dioxide or mixtures thereof, in proportions to provide a semi-frozen food product having the desired consistency. The liquid comestible product mix may be refrigerated by suitable apparatus (not shown) to pre-cool the product mix to a preselected temperature above the freezing temperature of the product mix prior to delivery to the chambers CI and C2. The beaters 22 rotates within its respective chamber CI, C2 so as churn the product mix resident within the chamber and also move the product mix to the forward end of the chamber for delivery to the dispensing valve 11. The blades of the beaters 22 may also be designed to pass along the inner surface of the inner cylinder 30 as the beater rotates so as to scrape frozen ice crystals of product from the inner surface of the inner cylinder 30. As the product mix churns within the chambers CI and C2, the product mix is chilled to the freezing point temperature to produce a semi-frozen product ready-on-demand for dispensing. If gas is added to the product mix, the gas is thoroughly and uniformly dispersed throughout the product mix as the beaters rotate.

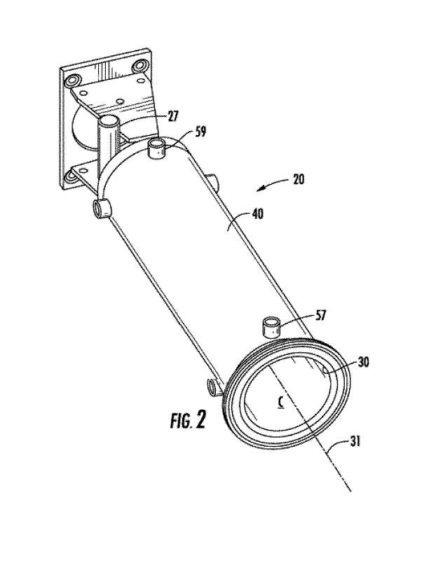

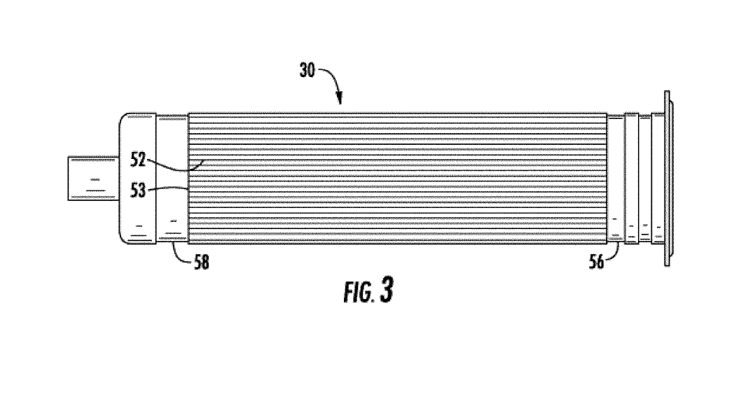

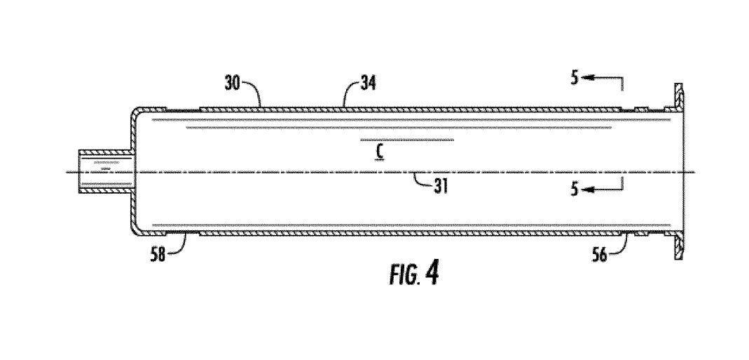

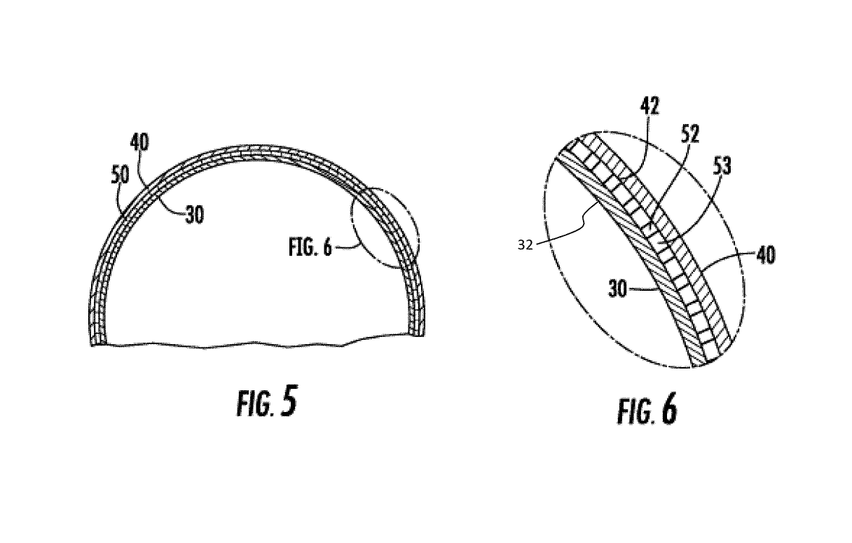

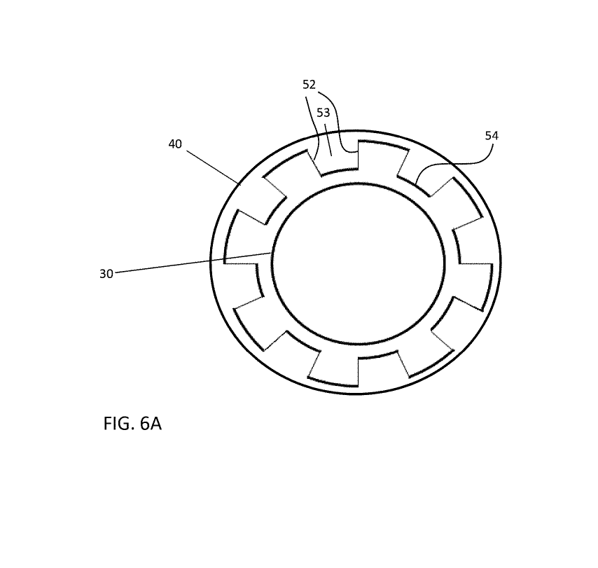

Referring now to FIGS. 2-6, in particular, each freezing barrel 20 includes an inner tube 30, an outer tube 40 circumscribing the inner tube 30, and an evaporator 50 formed between the inner tube 30 and the outer tube 40. As shown, the inner tube 30 includes a cylinder extending longitudinally along a central axis 31 and having an inner surface 32 (best shown in FIG. 6) bounding the freezing chamber C and an outer surface 34. Similarly, the outer tube 40 includes a cylinder extending longitudinally along the axis 31 and coaxially circumscribing the longitudinally extending inner cylinder 30. Although the inner and outer tubes 30, 40 are illustrated and described as being cylindrical in shape, it should be understood that in other embodiments, the inner and outer tubes 30, 40 may have any complementary shape. The outer tube 40 has an inner surface 42 facing the outer surface 34 of the inner cylinder 30.

The inner tube 30 may be made from food grade stainless steel or other metal approved for use in connection in food processing applications. A product supply tube 27 opens into the freezing chamber C through a first end of the inner cylinder 30 of the barrel 20, which end is also referred to herein as the feed end or aft end. The dispensing valve 11 is disposed at the axially opposite end of the barrel 20, which end is also referred to herein as the discharge end or forward end.

The outer surface 34 of the inner tube 30 is provided with a plurality of fins 52, and a plurality of channels 53 disposed at circumferentially spaced intervals in alternating relationship with a plurality of fins 52, about the circumference of the outer surface 34 of the inner tube 30. The fins 52 and channels 53 may be formed integrally with the shell of the first tube 30. For example, the fins 52 and channels 53 may be formed by machining material from the outer surface 34 of the inner cylinder 30 thereby simultaneously forming the channels 53 and the fins 52 that alternate with and extend radially outwardly between channels 53. Alternatively, the fins 52 may be integrally formed with the inner tube 30 via extrusion.

In an embodiment, the inner tube 30 has an outer shell diameter that nearly matches the inside shell diameter of the outer tube 40. The outer shell diameter of the inner tube 30 is defined by the distal end of the plurality of fins 52. As a result, when the channels 53 are formed in the outer surface 34 of the inner tube 30, thereby forming the plurality of the fins 52 of the inner tube 30, the fins 52 extend radially outwardly to abut the inner surface 42 of the outer tube 40 when the outer tube 40 is assembled about the inner tube 30.

In another embodiment, the plurality of fins 52 and the plurality of channels 53 of the evaporator 50 are formed by positioning one or more inserts 54 between the inner tube 30 and the outer tube 40. For example, each of the one or more inserts 54 has at least one radially extending portion that extends between the inner and outer tube 30, 40 and forms a fin 52 of the evaporator 50. The channels 53 of the evaporator 50 are defined between adjacent fins 52. In an embodiment, best shown in the exploded view of FIG. 6A, the insert 54 is a corrugated material wrapped about the outer periphery of the inner tube 30, or the inner periphery of the outer tube 40. However, it should be understood that one or more inserts having any configuration suitable to define the plurality of fins 52 and channels 53 of the evaporator 50 is contemplated herein.

The outer surface 34 of the inner tube 30 is also provided with a first recess 56 and a second recess 58 formed in and extending circumferentially about the outer surface 34 of the inner tube 30 at longitudinally spaced end regions of the inner tube 30. In the depicted exemplary embodiment the first recess 56 is at the product discharge end of the inner tube 30 and the second recess 58 is at the product feed end thereof. However, embodiments where the first recess 56 is adjacent the product feed end and/or the second recess 58 is adjacent the product discharge end are also contemplated herein. The outer tube 40 has at least one inlet opening 57 associated with the first recess 56 for receiving refrigerant from the refrigerant system 60 and has at least one outlet opening 59 associated with the second recess 58 for returning refrigerant to the refrigerant system 60. Although the freezing barrel 20 is described as having at least one inlet opening 57 and outlet opening 59, embodiments including a plurality of inlet openings 57 and/or outlet openings 59, such as spaced equidistantly about a circumference of the barrel 20 for example, are also within the scope of the disclosure.

Each channel 53 forms a refrigerant flow passage that extends between and establishes fluid flow communication between the first recess 56 and the second recess 58. In the depicted embodiment, each channel 53 of the plurality of channels extends longitudinally parallel to the axis 31 of the inner tube 30 between the first recess 56 and the second recess 58. Thus, the first recess 56 forms a refrigerant inlet header and the second recess forms a refrigerant outlet header which together with the channels 53 formed in the inner tube 30, in assembly with the outer tube 40, provides a heat exchanger. This heat exchanger forms the evaporator 50 of the freezing barrel 20 through which refrigerant is circulated in heat exchange relationship with the product resident within the freezing chamber C bounded by the inner surface of the inner tube 30 for chilling the product resident therein. The first recess 56 is connected in fluid flow communication via at least one inlet opening 57 with the refrigerant supply line 63 through valve 66 and line 67 to receive refrigerant into the evaporator 50, while the second recess 58 is connected in fluid flow communication via at least one outlet opening 59 with the refrigerant line 69 for passing refrigerant from the evaporator 50.

In an embodiment, each channel 53 of the plurality of channels defines a flow passage having a desired cross-sectional shape, such as for example a generally rectangular or square cross-sectional shape. Additionally, each channel 53 may be formed with a desired depth and a desired width to provide a flow passage having a desired hydraulic diameter. The plurality of channels 53 may be substantially identical in size and shape, or alternatively, may vary about the circumference of the freezing barrel 20. In an embodiment, each of the channels 53 defines a flow passage having a cross-sectional flow area having a hydraulic diameter in the range of about 0.02 inch to 0.10 inch (about 0.50 millimeter to 2.54 millimeters). For example, in an embodiment, each of the channels 53 may be machined to have a depth of 0.0625 inch (1.5875 millimeters) and a width of 0.0625 inch (1.5875 millimeters) thereby defining a flow passage having a cross-sectional flow area having a hydraulic diameter of about 0.0625 inch (1.5875 millimeters).

The plurality of channels 53 may be disposed at circumferentially equally spaced intervals about the circumference of the inner tube 30. For example, in an embodiment of the semi-frozen product dispensing apparatus 10 including an inner tube 30 of a freezing barrel 20 having an outer shell diameter of 4.1 inches (104 millimeters), a total of 128 equally circumferentially spaced channels 53 might be disposed about the circumference of the outer surface 34 of the inner tube 30.

The heat exchange efficiency of the evaporator 50 comprising a relatively large number of refrigerant flow channels, each having a relatively small hydraulic diameter, is significantly higher than that of evaporators having a single flow channel. Heat exchange is increased in part due to the increase in the effective heat transfer area between the refrigerant and the inner tube 30 due to the fins 52 flanking the channels 53 and in part due to the increased heat transfer effectiveness associated with the very small hydraulic diameter flow passages defined by the respective channels 53.

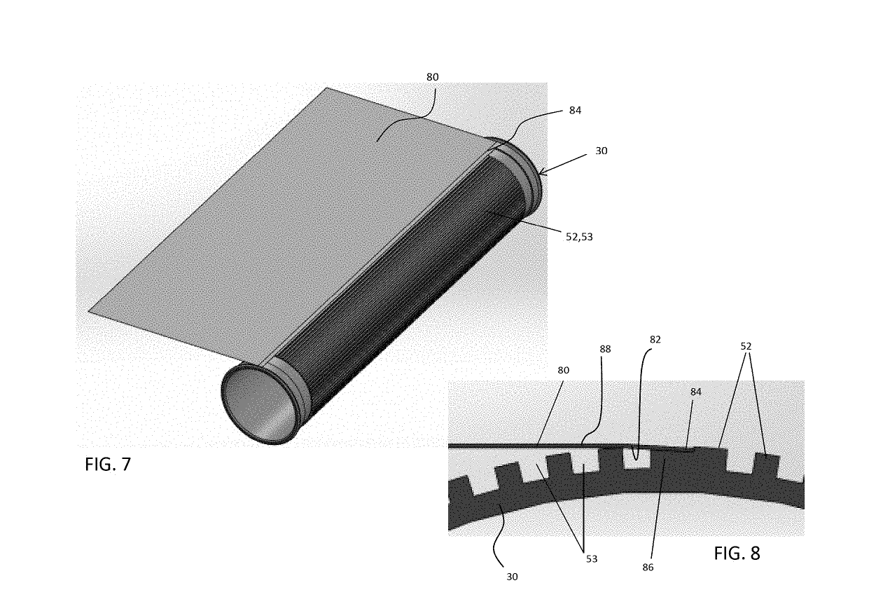

The outer tube 40 may be formed as a separate component and then installed about the outer surface 34 of the inner tube 30. Alternatively, the outer tube 40 may be formed and positioned about the inner tube 30 simultaneously. With reference now to FIGS. 7-12, the outer tube 40 is formed by wrapping a piece of material 80, such as sheet metal for example, about the inner tube 30. The thickness of the material 80 should be thin enough to allow the material 80 to bend about a radius without affecting the integrity of the material. In the illustrated, non-limiting embodiment, the material 80 used to form the outer tube 40 has a width, measured parallel to the longitudinal axis 31, substantially equal to a distance between a first end and a second opposite end of the inner tube 30.

A surface 82 of the material 80 adjacent a first end 84 is affixed over its entire width, or some percentage thereof, to the outer surface 34 of the inner tube 30, for example via a soldering, brazing, or welding operation. Accordingly, a seam is formed between the first end 84 of the material 80 and the inner tube 30. The first end 84 of the material 80 may be positioned in overlapping arrangement with a feature 86 formed in the outer surface 34 of the inner tube 30. As shown in FIG. 8, in an embodiment, the feature 86 includes a fin 52 having a partially reduced height compared to the remainder of the plurality of fins 52. The height of the fin 52 that forms the feature 86 may be reduced by an amount substantially equal to the thickness of the material 80 such that when the first end 84 is positioned thereon, the exposed surface 88 of the material 80 is substantially aligned with the outer surface 34 of the inner tube 30.

Once the first end 84 of the material 80 is connected to the inner tube 30, as shown in FIG. 7, the material 80 is then wrapped about the outer surface 34 of the inner tube 30. In an embodiment, the material 80 is “wrapped” by rotating the inner tube 30 while maintaining a tension in the sheet of material 80. As a result, the sheet of material will bend or wrap about the inner tube 30 to form an outer tube 40 having a shape corresponding to the inner tube 30. Further, as the material is wrapped about the outer surface 34 of the inner tube 30, the tension in the material 80 ensures that the material 80 is in direct contact with the distal end of each of the plurality of fins 52 over the axial width of the inner tube 30. Through this engagement, the material 80 forms a boundary to the plurality of channels 53 defined between the plurality of fins 52, to contain the refrigerant flow within the individual channels 53.

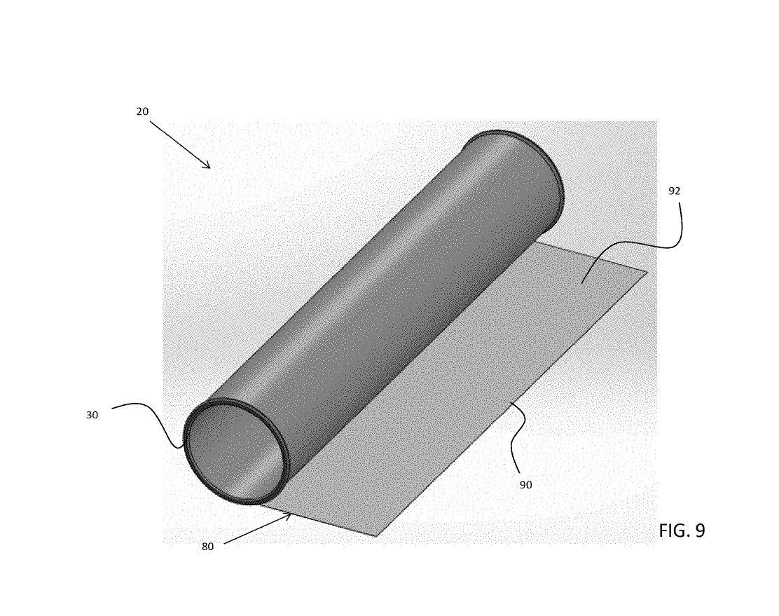

The length of the material 80 wrapped about the inner tube 30 may vary. For example, the length of the material 80 may be selected such that the material 80 is wrapped around more than 360 degrees of the circumference of the inner tube 30, as shown in FIG. 9. As a result, the material 80 has a multi-wrap configuration where at least a portion of the outer tube 40 includes multiple layers of material 80 stacked in a direct overlapping relationship. As used herein, one wrap of the material 80 is defined as when the material 80 extends 360 degrees about the inner tube 30. In an embodiment, the length of the material 80 wrapped about the inner tube 30 is selected to form an outer tube 40 having approximately two wraps, three wraps, four wraps, or any number of wraps including partial wraps there between. However, it should be understood that an outer tube 40 formed via any number of wraps is contemplated herein. Accordingly, an outer tube 40 having only a single wrap is within the scope of the disclosure.

The second end of the sheet of material 80 may be attached to a portion of the inner tube 30 or to an adjacent portion of the sheet of material 80 via a soldering, brazing, or welding operation. In an embodiment, a weld affixing the second end of the sheet of material 80 to the tube 80 penetrates each of the layers formed by the material 80 to join the layers at a location. In addition, in embodiments where the length of the material is sufficient to form an outer tube 40 having a multi-wrap configuration, i.e. extends about more than 360 degrees of the circumference of the inner tube 30, a second end 90 of the sheet of material 80 is arranged at a circumferential position offset from the first end 84 relative to the inner tube 30. In addition, the end joints formed at the sides of the material 80 adjacent the first end and the second, opposite end of the barrel 20 may be soldered, brazed, or welded, to restrict movement of the material 80 from the inner tube 30 and maintain the sealed configuration of the channels 53.

In some embodiments, an adhesive may be applied to a surface, illustrated at 92 in FIG. 9, of the material 80 prior to or while wrapping the material 80 about the inner tube 30. In embodiments where the outer tube 40 has a multi-wrap configuration, the adhesive may be used to adhere the material 80 to the outer surface 34 of the inner tube and/or to join a surface of the material to another portion of the sheet of material 80 in overlapping arrangement. In embodiments where the adhesive is activated in response to heat, such as where the adhesive is solder for example, the barrel 20 may be heated to cure the adhesive prior to use in an apparatus 10.

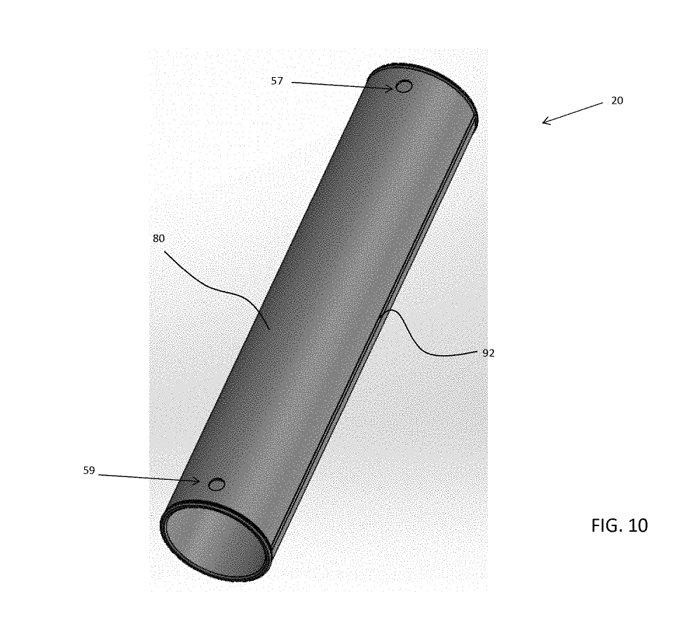

With reference to FIG. 10, the inlet opening 57 and the outlet opening 59 may be formed, such as via a machining operation, after the material 80 has been wrapped about the inner tube 30. In another embodiment, the inlet opening 57 and the outlet opening 59 may be formed in the material 80 prior to installation of the material about the inner tube 30. In embodiments where the outer tube 40 is formed via a single wrap, each inlet opening 57 and outlet opening 59 is formed via one or more holes in the material 80.

In embodiments where the outer tube 40 has a multi-wrap configuration, a plurality of inlet holes and/or outlet holes may be formed at spaced intervals over the length of the material 80. Each of the plurality of inlet holes and/or outlet holes is associated with one wrap of the multi-wrap configuration. The inlet holes and/or outlet holes within adjacent wraps are positioned such that when the material is wrapped about the inner tube 30, adjacent inlet holes and adjacent outlet holes overlap, respectively to define a fluid flow path. Further, in an embodiment, a diameter of each of the inlet holes and/or outlet holes gradually increases with each subsequent wrap of the material 80 about the inner tube 30. As a result, the inlet opening 57 and/or outlet opening 59 will have a generally conical or chamfered configuration which may better accommodate the attachment of a connection therein while forming a seal between adjacent layers.

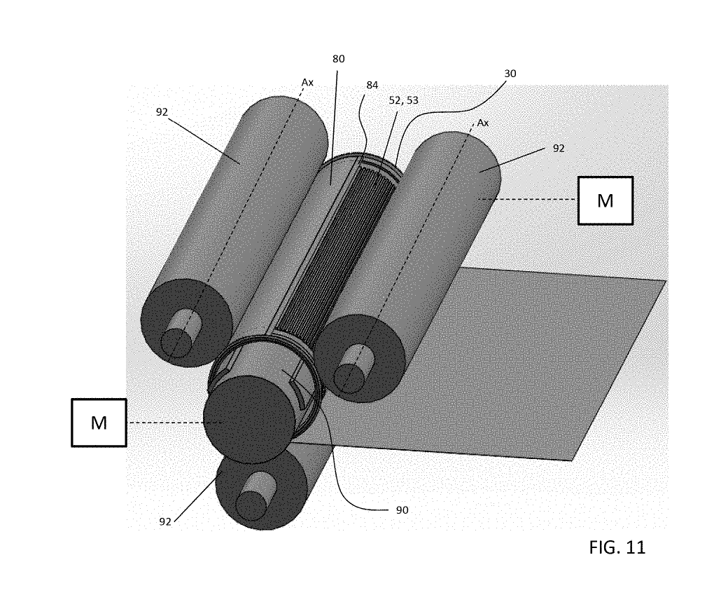

In an embodiment, illustrated in FIG. 11, the inner tube 30 may be rotatably coupled to and supported by an expanding center support 94. One of the inner tube 30 and the expanding center support 90 may be operably coupled to a motor, illustrated schematically at M. The motor M is configured to drive rotation of both the inner tube 30 and the expanding center support 90 about the longitudinal axis 31.

One or more support rollers 92 may, but need not be, located about the periphery of the inner tube 30. Although three support rollers 92 are included in the illustrated, non-limiting embodiment, it should be understood that embodiments having any number of support rollers 92, including a single support roller, two support rollers and four or more support rollers are also within the scope of the disclosure. The one or more support rollers 92 are oriented such that an axis Ax of the one or more support rollers 96 is substantially parallel to the longitudinal axis 31 of the inner tube 30. In an embodiment, at least one of the support rollers 92 is configured to contact the outer surface 34 of the inner tube 30 such that rotational motion is transmitted between the inner tube 30 and the support roller 92. The support roller 96 may be driven about an axis Ax by a motor coupled thereto, illustrated schematically at M, and engagement between the support roller 92 and the inner tube 30 may drive rotation of the inner tube 30 about the axis 31 such that both the support roller 96 and the inner tube 30 rotate at the same relative speed. However, embodiments where the support roller 92 is driven by the inner tube 30 or where the support roller 96 and the inner tube 30 are driven independently are also contemplated herein.

Alternatively, or in addition, at least one of the support rollers 92 may be configured to assist with the bending of the material 80 about the exterior of the inner tube 30. In such embodiments, the at least one support roller 92 may be offset from the outer surface 34 of the inner tube 30, such as by a distance substantially equal to or greater than the thickness of the material for example. This distance between the surface of the support roller 92 and the outer surface 34 of the inner tube 30 will vary based on how many layers or wraps of the material 80 are configured to be formed about the outer surface 34 of the inner tube 30.

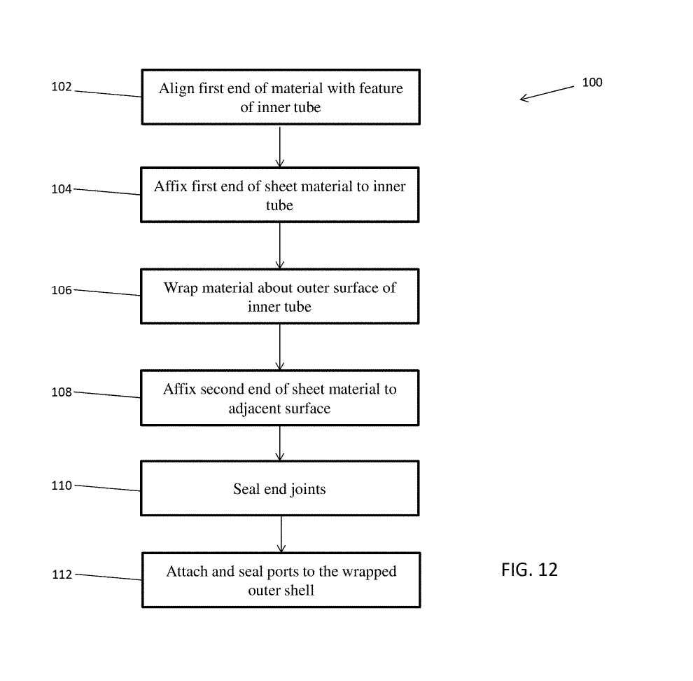

A flow diagram of a method of forming the outer tube 100 is illustrated in more detail in FIG. 12. In block 102, the first end 84 of the sheet of material 80 is aligned with a feature 86 formed in the inner tube 30, and in block 104, the first end 84 is affixed to the outer surface 34 of the inner tube 30 to form a seam there between. Once the seam is formed, the sheet of material is wrapped one or more times about the outer surface 34 of the inner tube 30, as shown in block 106. The first wrap of the sheet of material is in direct contact with the distal ends of the plurality of fins 52 that defined the outer surface 34 of the inner tube 30. Subsequent wraps formed by the sheet of material 80 overlap an adjacent layer of the sheet of material 80. In block 108, once wrapping the material about the inner tube 30 is completed, a second, opposite end of the sheet of material 80 is affixed to an adjacent surface, such as of material 80 to form a seam over the width of the second end. In block 110, the end joints of the sheet of material are similarly sealed via a soldering, brazing, or welding operation. In embodiments where the inlet opening 57 and the outlet opening 59 are formed by wrapping the material 80 about the outer shell, in block 112, ports are attached and sealed to the barrel 20 to couple the barrel to a refrigeration system 60.

The method of making the heat exchanger 50 and freezing barrel 20 described herein may be adapted for barrels having different diameters and lengths. Further, the manufacturing method may be scaled for heat exchangers 50 having different refrigerant pressures by varying the thickness and/or strength of the sheet metal material 80 and the total number of wraps formed about the inner tube 30.

The terminology used herein is for the purpose of description, not limitation. Specific structural and functional details disclosed herein are not to be interpreted as limiting, but merely as basis for teaching one skilled in the art to employ the present invention. While the present invention has been particularly shown and described with reference to the exemplary embodiments as illustrated in the drawing, it will be recognized by those skilled in the art that various modifications may be made without departing from the spirit and scope of the invention. Those skilled in the art will also recognize the equivalents that may be substituted for elements described with reference to the exemplary embodiments disclosed herein without departing from the scope of the present invention.

Therefore, it is intended that the present disclosure not be limited to the particular embodiment(s) disclosed as, but that the disclosure will include all embodiments falling within the scope of the appended claims.

What is claimed is:

1. A method of making a heat exchanger comprising:
providing an inner tube extending longitudinally along a central axis and having an inner surface bounding a product chamber and an outer surface;
forming an outer tube; and
positioning the outer tube about the inner tube, the outer tube being disposed coaxially about and circumscribing the inner tube in a radially spaced relationship;
wherein forming the outer tube and positioning the outer tube about the inner tube occur simultaneously.

2. The method of claim 1, wherein forming the inner tube further comprises forming one or more wraps of a sheet of material about the plurality of fins.

3. The method of claim 2, wherein an adhesive is positioned on a surface of the sheet of material.

4. The method of claim 1, wherein forming one or more wraps of a sheet of material about the plurality of fins further comprises:
affixing an end of the sheet of material to outer surface of the inner tube; and rotating the inner tube about the central axis.

5. The method of claim 4, wherein tension is applied to sheet of material as the inner tube rotates about the central axis.

6. The method of claim 4, wherein affixing the end of the sheet of material to the outer surface of the inner tube includes welding the end of the sheet of material to the outer surface of the inner tube.

7. The method of claim 4, wherein the outer surface of the inner tube further comprises a feature for receiving an end of the sheet of material, and affixing the end of the sheet of material to the outer surface of the inner tube includes affixing the end of the sheet of material to the feature.

8. The method of claim 7, wherein the feature includes a fin extending from the outer surface of inner tube.

9. The method of claim 4, further comprising affixing another end of the sheet of material to an adjacent surface.

10. The method of claim 9, wherein the adjacent surface is a portion of the sheet of material.

11. The method of claim 9, wherein the end and another end are offset from one another about a circumference of the inner tube.

12. The method of claim 4, wherein rotating the inner tube about the central axis includes rotating the inner tube more than 360 degrees about the central axis such that at least a portion of the outer tube includes overlapping layers of the sheet of material.

13. The method of claim 1, further comprising forming at least one of an inlet opening and an outlet opening in the outer tube.

14. The method of claim 13, wherein forming at least one of an inlet opening and an outlet opening in the outer tube and forming the outer tube occur simultaneously.

15. The method of claim 13, wherein at least one of the inlet opening and the outlet opening is generally conical in shape.

16. The method of claim 1, wherein a plurality of channels is disposed circumferentially between the outer tube and the inner tube.

17. The method of claim 16, wherein the plurality of channels is formed into at least one of the inner tube and the outer tube.

18. The method of claim 16, wherein the plurality of channels is formed via an insert located between the inner tube and the outer tube.

19. A heat exchanger comprising:
an inner tube extending longitudinally along a central axis and having an inner surface bounding a product chamber and an outer surface;
a plurality of channels disposed about the outer surface of the inner tube;
a longitudinally extending outer tube disposed coaxially about and circumscribing the inner tube in radially spaced relationship, wherein the outer tube is formed from a sheet metal material and at least a portion of the outer tube includes a plurality of stacked layers of the sheet metal material.

20. The heat exchanger of claim 19, wherein the outer tube is formed from a sheet metal material wrapped about the outer surface of the inner tube.
